(19) United States
(12) Patent Application Publication
(10) Pub. No.: US 2025/0388073 A1
(43) Pub. Date: Dec. 25, 2025

(54) GENERATOR WITH INTEGRATED DAMPER

(71) Applicant: Schaeffler Technologies GmbH & Co. KG, Herzogenaurach (DE)

(72) Inventors: Noah Kee, Rittman, OH (US); Matthew Payne, Glenmont, OH (US); Aditya Dattawadkar, Strongsville, OH (US)

(73) Assignee: Schaeffler Technologies GmbH & Co. KG, Herzogenaurach (DE)

(21) Appl. No.: 19/241,469

(22) Filed: Jun. 18, 2025

Related U.S. Application Data
(60) Provisional application No. 63/662,094, filed on Jun. 20, 2024.

(51) Int. Cl. B60K 6/26; F16D 3/12; F16D 3/66; H02K 7/18

(52) U.S. Cl. CPC B60K 6/26; F16D 3/12; F16D 3/66; H02K 7/1815; B60Y 2200/92; B60Y 2400/60; F16D 2300/22

(57) ABSTRACT

A generator module for a vehicle includes a housing arranged for fixing to a combustion engine, a stator fixed in the housing, a rotor, rotatable within the stator and arranged for driving connection with the combustion engine, and a damper arranged in a torque path between the combustion engine and the rotor for damping torsional vibrations from the combustion engine.

### CROSS-REFERENCE TO RELATED APPLICATIONS

This application claims the benefit of U.S. Provisional Patent Application No. 63/662,094, filed Jun. 20, 2024, the disclosure of which is incorporated in its entirety by reference herein.

### TECHNICAL FIELD

The present disclosure relates generally to a generator module for a vehicle, and more specifically to a generator with integrated damper.

### BACKGROUND

Hybrid modules with dampers are known from commonly assigned PCT Publication No. WO 2023/078494 A1 titled ELECTRIC MACHINE FOR GENERATING ELECTRICAL ENERGY AND FOR GENERATING A TORQUE, AND DRIVE UNIT FOR A HYBRID VEHICLE to Voit et al., for example, hereby incorporated by reference as if set forth fully herein.

### SUMMARY

Example embodiments broadly comprise a generator module for a vehicle including a housing arranged for fixing to a combustion engine, a stator fixed in the housing, a rotor, rotatable within the stator and arranged for driving connection with the combustion engine, and a damper arranged in a torque path between the combustion engine and the rotor for damping torsional vibrations from the combustion engine. In an example embodiment, the damper includes a spring at least partially aligned with the rotor in an axial direction.

In some example embodiments, the generator module also includes a bulkhead wall fixed to the housing and a bearing. The rotor includes a rotor carrier and the bearing centers the rotor carrier with respect to the bulkhead wall. In some example embodiments, the generator module also includes a hub, and the damper is drivingly connected to the hub. In an example embodiment, the generator module also includes a bushing, and the bushing centers the hub with respect to the rotor carrier.

In some example embodiments, the damper includes an input side drivingly connected to the hub and an output side drivingly connected to the rotor carrier. In an example embodiment, the output side includes a pair of plates fixed together by a spacer rivet, and the input side comprises a radially extending tab aligned with the spacer rivet. In an example embodiment, the hub includes a radially extending tab, and the input side comprises an axially extending tab engaged with the radially extending tab.

In some example embodiments, the rotor carrier includes a first slot, and the output side includes a first axially extending tab engaged with the first slot. In some example embodiments, the hub includes a radially extending tab, the rotor carrier includes a second slot, and the input side includes a second axially extending tab extending through the second slot and engaged with the radially extending tab. In an example embodiment, the second slot is radially inside of the first slot. In an example embodiment, the second slot is circumferentially longer than the first slot and overlaps the first slot in a radial direction.

In some example embodiments, the input side is fixed to the hub by a staked connection, and the output side is fixed to the rotor carrier by a fastener. In an example embodiment, the input side includes a radially extending tab, and the output side includes a circumferentially extending tab aligned with the radially extending tab. In some example embodiments, the damper includes a spring disposed radially inside of the rotor. In an example embodiment, the spring is at least partially axially aligned with the bearing.

In some example embodiments, the damper includes an input side arranged for driving connected to the combustion engine, and an output side drivingly connected to the hub. In an example embodiment, the hub is fixed to the rotor carrier. In an example embodiment, the damper is a dry damper. In an example embodiment, the damper is a grease-filled damper.

### BRIEF DESCRIPTION OF THE DRAWINGS

FIG. 1 illustrates a partial cross-sectional view of a generator module according to a first example embodiment.

FIG. 2 illustrates an end view of a portion of the generator module of FIG. 1.

FIG. 3 illustrates a partial cross-sectional view of a generator module according to a second example embodiment.

FIG. 4 illustrates a partial cross-sectional view of a generator module according to a third example embodiment.

FIG. 5 illustrates a partial cross-sectional view of a generator module according to a fourth example embodiment.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

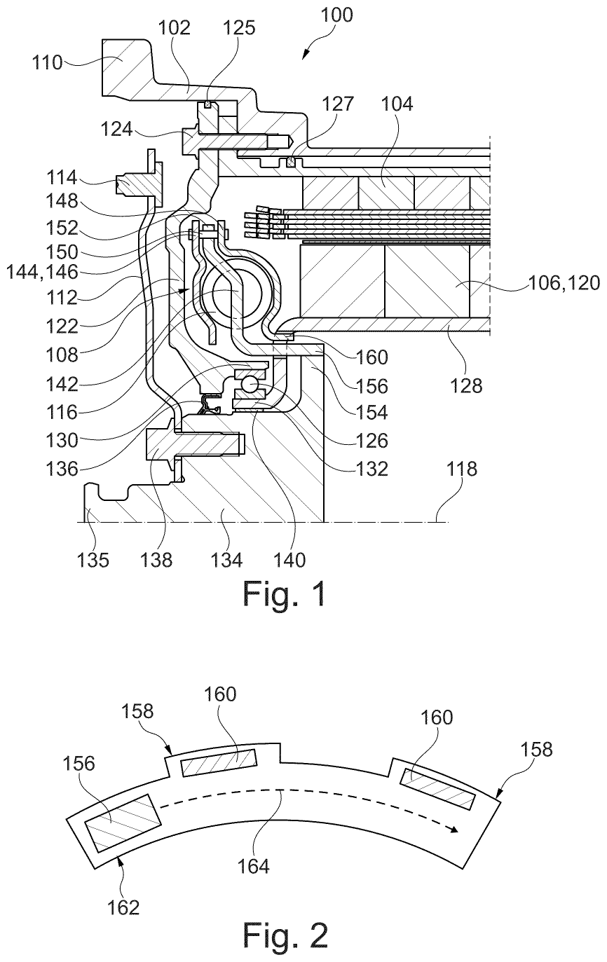

The following description is made with reference to FIGS. 1-2. FIG. 1 illustrates a partial cross-sectional view of generator module 100. FIG. 2 illustrates an end view of a portion of generator module 100 of FIG. 1. Generator module 100 for a vehicle includes housing 102 arranged for fixing to a combustion engine (not shown), stator 104 fixed in the housing, rotor 106, rotatable within the stator and arranged for driving connection with the combustion engine, and damper 108 arranged in a torque path between the combustion engine and the rotor for damping torsional vibrations from the combustion engine. Housing 102 includes mounting flange 110 for fixing to an engine block of the combustion engine, for example, and the generator module includes drive plate 112 with studs 114 for driving connection with a combustion engine flexplate (not shown) or flywheel (not shown), for example.

Damper 108 includes spring 116 at least partially aligned with the rotor in an axial direction. By at least partially aligned in an axial direction, we mean that a line parallel to axis 118 can be drawn that extends through both the spring and the rotor (e.g., rotor segments 120). Module 100 also includes bulkhead wall 122 fixed to the housing (e.g., by bolts 124) and bearing 126. Seals 125 and 127 seal the stator and bulkhead wall, respectively, to the housing. Bolts 124 also fix the stator to the housing. Rotor 106 includes rotor carrier 128 and bearing 126 centers the rotor carrier with respect to the bulkhead wall. That is, the bearing is arranged between cylindrical portions 130 and 132 of the bulkhead wall and the rotor carrier, respectively, to rotatably support the rotor carrier for relative rotation with the bulkhead wall. Generator module 100 also includes hub 134 and damper 108 is drivingly connected to the hub as described below.

Hub 134 includes pilot 135 arranged to position the hub in a crankshaft (not shown) of the combustion engine, for example. Hub 134 is sealed to bulkhead wall 122 by seal 136 to keep lubricant and cooling fluid, for example, retained within the generator module, and drivingly connected to drive plate 112 via bolts 138, for example. Generator module 100 also includes bushing 140 and the bushing centers the hub with respect to the rotor carrier. That is, the bushing fits between respective cylindrical surfaces of the hub and the rotor carrier to rotatably support the rotor carrier on the hub during relative rotation of the damper.

Damper 108 includes input side 142 drivingly connected to the hub and output side 144 drivingly connected to the rotor carrier. Output side 144 includes plates 146 and 148 fixed together by spacer rivet 150. Input side 142 includes radially extending tab 152 aligned with the spacer rivet such that, after a predetermined rotation of the input side relative to the output side, the tab contacts the spacer rivet to prevent further compression of spring 116. Hub 134 includes radially extending tab 154 and input side 142 includes axially extending tab 156 engaged with the hub radially extending tab. Tabs 154 and 156 drivingly connect the input side with the hub as discussed above. Similarly, rotor carrier 128 includes slot 158 and the output side (e.g., plate 148) includes axially extending tab 160 engaged with slot 158. Tab 160 and slot 158 drivingly engage the output side with the rotor carrier as discussed above.

Rotor carrier 128 also includes slot 162 and tab 156 extends through slot 162 to engage radially extending tab 154. As shown in FIG. 2, for example, slot 162 is radially inside of slot 158. Slot 162 is also circumferentially longer than slot 158 and overlaps slot 158 in a radial direction. That is, a radial line can be drawn that extends through both slot 158 and slot 162. As also shown in FIG. 2, for example, slots 158 and 162 may be combined in a single large slot that may include a plurality of slots 158. Travel of tab 160 through slot 162 as the damper input rotates relative to the damper output is shown by arrow 164.

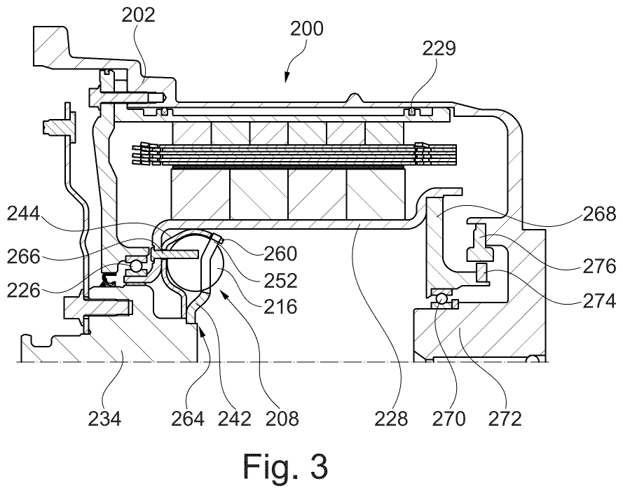

The following description is made with reference to FIG. 3. FIG. 3 illustrates a partial cross-sectional view of generator module 200. Operation of generator module 200 is similar to operation of generator module 100 described above with all 2XX reference numerals in FIG. 3 generally corresponding to 1XX reference numerals in FIG. 1 except as described below. Generator module 200 includes damper 208 with input side 242 and output side 244. Input side 242 is fixed to hub 234 by staked connection 264 and output side 244 is fixed to rotor carrier 228 by fastener 266. Input side 242 includes radially extending tab 252 and output side 244 includes circumferentially extending tab 260 aligned with radially extending tab 252.

As shown in FIG. 3, generator module 200 includes spring 216 disposed radially inside of the rotor. That is, rotor carrier 228 includes a radially internal cavity and the spring is disposed within the radially internal cavity. Spring 216 is at least partially axially aligned with bearing 226. That is, a line can be drawn parallel to axis 218 that extends through both spring 216 and bearing 226. Module 200 also includes rotor carrier hub 268 supported by bearing 270 on axial protrusion 272 of housing 202. Hub 268 supports resolver rotor 274 and resolver stator 276 is fixed to the housing. Seal 229 seals the stator to the housing.

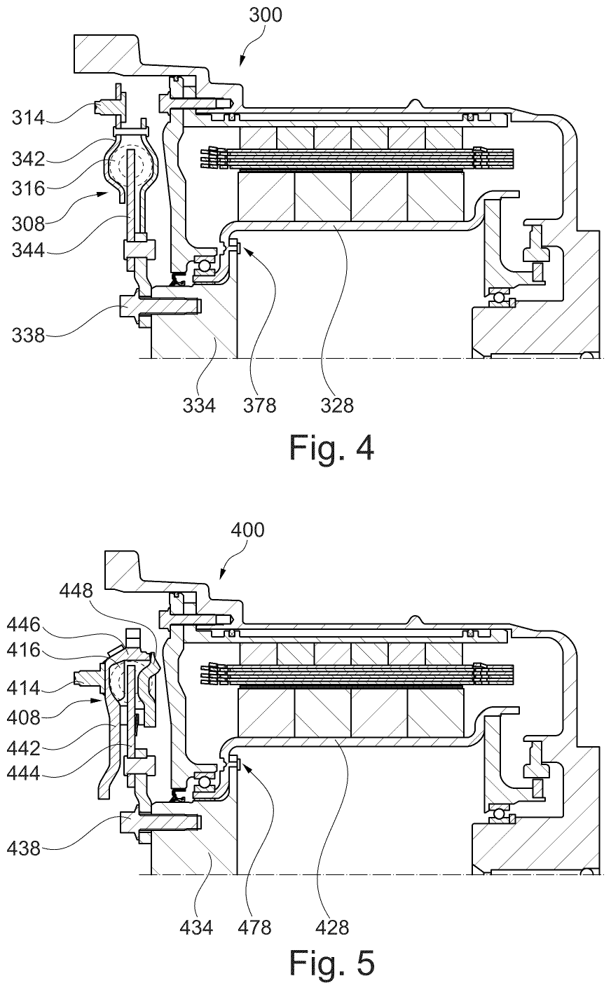

The following description is made with reference to FIG. 4. FIG. 4 illustrates a partial cross-sectional view of generator module 300. Operation of generator module 300 is similar to operation of generator module 100 described above with all 3XX reference numerals in FIG. 4 generally corresponding to 1XX reference numerals in FIG. 1 except as described below. Generator module 300 includes damper 308 with input side 342 and output side 344. Input side 342 is arranged for driving connected to the combustion engine. That is, input side 342 includes studs 314 for driving connection with a combustion engine flexplate (not shown) or flywheel (not shown), for example, similar to studs 114 described above. Output side 344 is drivingly connected to hub 334 (e.g., by bolts 338). Spring 316 is arranged between the input side and the output side to allow relative rotation therebetween. Hub 334 is fixed to rotor carrier 328 by extruded rivet connection 378. By an extruded rivet connection, we mean that some material is extruded from the rotor carrier and inserted into a hole in the hub before being upset, similar to a rivet. In the embodiment shown in FIG. 4, damper 308 is a dry damper and does not receive any lubrication from the generator module or internal lubrication.

The following description is made with reference to FIG. 5. FIG. 5 illustrates a partial cross-sectional view of generator module 400. Operation of generator module 400 is similar to operation of generator module 100 described above with all 4XX reference numerals in FIG. 5 generally corresponding to 1XX reference numerals in FIG. 1 except as described below. Generator module 400 includes damper 408 with input side 442 and output side 444. Input side 444 is arranged for driving connected to the combustion engine. That is, input side 442 includes studs 414 for driving connection with a combustion engine flexplate (not shown) or flywheel (not shown), for example, similar to studs 114 described above. Output side 444 is drivingly connected to hub 434 (e.g., by bolts 438). Spring 416 is arranged between the input side and the output side to allow relative rotation therebetween. Hub 434 is fixed to rotor carrier 428 by extruded rivet connection 478. By an extruded rivet connection, we mean that some material is extruded from the rotor carrier and inserted into a hole in the hub before being upset, similar to a rivet. In the embodiment shown in FIG. 5, damper 408 is a grease-filled damper. That is, input side 442 includes plates 446 and 448 fixed and sealed together (e.g., by welding, staking or adhesives) to form a chamber for receiving a grease that lubricates spring 416 during operation.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Generator module
102 Housing
104 Stator
106 Rotor
108 Damper
110 Mounting flange (housing)
112 Drive plate
114 Studs (drive plate)
116 Spring
118 Axis
120 Rotor segments
122 Bulkhead wall
124 Bolts (bulkhead wall to housing)
125 Seal (bulkhead wall to housing)
126 Bearing
127 Seal (stator to housing)
128 Rotor carrier
130 Cylindrical portion (bulkhead wall)
132 Cylindrical portion (rotor carrier)
134 Hub
135 Pilot (hub)
136 Seal (hub to bulkhead wall)
138 Bolts (drive plate to hub)
140 Bushing
142 Input side (damper)
144 Output side (damper)
146 Plate (output side)
148 Plate (output side)
150 Spacer rivet
152 Radially extending tab (input side)
154 Radially extending tab (hub)
156 Axially extending tab (input side)
158 Slot (first, rotor carrier)
160 Axially extending tab (output side)
162 Slot (second, rotor carrier)
164 Arrow (tab travel in slot)
200 Generator module
202 Housing
208 Damper
216 Spring
218 Axis
226 Bearing
228 Rotor carrier
229 Seal (stator to housing)
234 Hub
242 Input side (damper)
244 Output side (damper)
252 Radially extending tab (input side)
260 Circumferentially extending tab (output side)
264 Staked connection (input side to hub)
266 Fastener (output side to rotor carrier)
268 Rotor carrier hub
270 Bearing
272 Axial protrusion (housing)
274 Resolver rotor
276 Resolver stator
300 Generator module
308 Damper
314 Studs (input side)
316 Spring
328 Rotor carrier
334 Hub
338 Bolts (output side to hub)
342 Input side (damper)
344 Output side (damper)
378 Extruded rivet connection (rotor carrier to hub)
400 Generator module
408 Damper
414 Studs (input side)
416 Spring
428 Rotor carrier
434 Hub
438 Bolts (output side to hub)
442 Input side (damper)
444 Output side (damper)
446 Plate (input side)
448 Plate (input side)
478 Extruded rivet connection (rotor carrier to hub)

What is claimed is:

1. A generator module for a vehicle, comprising:
a housing arranged for fixing to a combustion engine;
a stator fixed in the housing;
a rotor, rotatable within the stator and arranged for driving connection with the combustion engine; and
a damper arranged in a torque path between the combustion engine and the rotor for damping torsional vibrations from the combustion engine.

2. The generator module of claim 1 wherein the damper comprises a spring at least partially aligned with the rotor in an axial direction.

3. The generator module of claim 1 further comprising:
a bulkhead wall fixed to the housing; and
a bearing, wherein:
the rotor comprises a rotor carrier; and
the bearing centers the rotor carrier with respect to the bulkhead wall.

4. The generator module of claim 3 further comprising a hub, wherein the damper is drivingly connected to the hub.

5. The generator module of claim 4 further comprising a bushing, wherein the bushing centers the hub with respect to the rotor carrier.

6. The generator module of claim 4 wherein the damper comprises:
an input side drivingly connected to the hub; and
an output side drivingly connected to the rotor carrier.

7. The generator module of claim 6 wherein:
the output side comprises a pair of plates fixed together by a spacer rivet; and
the input side comprises a radially extending tab aligned with the spacer rivet.

8. The generator module of claim 6 wherein:
the hub comprises a radially extending tab; and
the input side comprises an axially extending tab engaged with the radially extending tab.

9. The generator module of claim 6 wherein:
the rotor carrier comprises a first slot; and
the output side comprises a first axially extending tab engaged with the first slot.

10. The generator module of claim 9 wherein:
the hub comprises a radially extending tab;
the rotor carrier comprises a second slot; and
the input side comprises a second axially extending tab extending through the second slot and engaged with the radially extending tab.

11. The generator module of claim 10 wherein the second slot is radially inside of the first slot.

12. The generator module of claim 10 wherein the second slot is circumferentially longer than the first slot and overlaps the first slot in a radial direction.

13. The generator module of claim 6 wherein:
the input side is fixed to the hub by a staked connection; and
the output side is fixed to the rotor carrier by a fastener.

14. The generator module of claim 13 wherein:
the input side comprises a radially extending tab; and
the output side comprises a circumferentially extending tab aligned with the radially extending tab.

15. The generator module of claim 13 wherein the damper comprises a spring disposed radially inside of the rotor.

16. The generator module of claim 15 wherein the spring is at least partially axially aligned with the bearing.

17. The generator module of claim 4 wherein the damper comprises:
an input side arranged for driving connected to the combustion engine; and
an output side drivingly connected to the hub.

18. The generator module of claim 17 wherein the hub is fixed to the rotor carrier.

19. The generator module of claim 17 wherein the damper is a dry damper.

20. The generator module of claim 17 wherein the damper is a grease-filled damper.
